(19) United States
(12) Patent Application Publication
(10) Pub. No.: US 2023/0323573 A1
(43) Pub. Date: Oct. 12, 2023

(54) WRAPPABLE, WOVEN EMI RESISTANT SLEEVE AND METHOD OF CONSTRUCTION THEREOF

(71) Applicant: FEDERAL-MOGUL POWERTRAIN LLC, Northville, MI (US)

(72) Inventors: Thomas Sueur, Crepy-En-Valois (FR); Thibaut Lesur, Clairoix (FR); Amelie Simoens, Compiegne (FR)

(21) Appl. No.: 18/132,542

(22) Filed: Apr. 10, 2023

Related U.S. Application Data
(60) Provisional application No. 63/329,689, filed on Apr. 11, 2022.

(51) Int. Cl. D03D 1/00; D03D 15/283; D03D 15/258; D03D 15/37; D03D 15/533

(52) U.S. Cl. CPC D03D 1/0043; D03D 1/0058; D03D 15/283; D03D 15/258; D03D 15/37; D03D 15/533; D10B 2401/16; D10B 2101/20; D10B 2331/301

(57) ABSTRACT

A wrappable woven sleeve includes a wall having opposite edges extending lengthwise between opposite ends. The opposite edges are configured to be wrapped about a central longitudinal axis, whereupon the wall takes on a tubular configuration with an inner surface of the wall bounding an enclosed cavity sized for receipt of an elongate member to be protected therein and an outer surface of the wall facing radially outwardly from the central longitudinal axis. The wall is woven with warp filaments extending generally parallel to the central longitudinal axis and weft filaments extending generally transversely to the warp filaments. One or more of the warp filaments are wire to shield against passage of low frequency EMI. A foil layer is fixed to the outer and/or inner surfaces of the wall to shield against passage of high frequency EMI.

### CROSS-REFERENCE TO RELATED APPLICATION

This application claims the benefit of U.S. Provisional Application Ser. No. 63/329,689, filed Apr. 11, 2022, which is incorporated herein by reference in its entirety.

### BACKGROUND OF THE INVENTION

### 1. Technical Field

This invention relates generally to textile sleeves for protecting elongate members, and more particularly to wrappable woven sleeves with electromagnetic interference resistant properties.

### 2. Related Art

It is known to contain and protect elongate members, such as wires and wire harnesses, for example, in wrappable woven sleeves to provide protection to the wires against electromagnetic interference (EMI). Although, these sleeves are generally effective to shield EMI at low frequencies, less than 1 MHz, improvements are desired, particularly with high frequency EMI, greater than 100 MHz, given the ever-increasing demand for high frequency electrical transmissions, such as via use of 5G devices. Accordingly, it is desired to have a single sleeve that is effective to shield both low and high frequency signals. Further yet, in order to provide optimal protection in physically demanding environments, such as those encountered in motor vehicles, by way of example, the wrappable sleeve should also possess high durability, be impact resistant, while being flexible to allow the sleeve to be routed about corners and over meandering paths. Further, it is desired that the sleeve have a few layers as possible to allow the sleeve to attain a lower profile, while being lightweight.

### SUMMARY OF THE INVENTION

One aspect of the invention provides a wrappable woven sleeve for routing and protecting an elongate member from exposure to EMI, while further providing mechanical protection against abrasion, impact, and other environmental conditions, such as contamination. The sleeve includes a wall having opposite edges extending lengthwise between opposite ends. The opposite edges are configured to be wrapped about a central longitudinal axis, whereupon the wall takes on a tubular configuration with an inner surface of the wall bounding an enclosed cavity sized for receipt of the elongate member therein and an outer surface of the wall facing radially outwardly from the central longitudinal axis. The wall is woven with warp filaments extending generally parallel to the central longitudinal axis and weft filaments extending generally transversely to the warp filaments. One or more of the warp filaments are wire to enhance shielding the elongate member against low frequency EMI (below 100 MHz). A foil layer is fixed to at least one of the outer surface and the inner surface of the wall to enhance shielding the elongate member against high frequency (about 100 MHz) and very high (above 1000 MHz) EMI.

In accordance with another aspect of the invention, the wire can have a copper core encapsulated by an outer layer of tin.

In accordance with another aspect of the invention, each of the warp filaments can be provided as wire.

In accordance with another aspect of the invention, one or more of the weft filaments can be heat-set to bias the opposite edges into overlapping relation with one another.

In accordance with another aspect of the invention, the heat-set weft filaments can be provided as monofilaments to maximize the bias imparted to bring the opposite edges into overlapping relation with one another.

In accordance with another aspect of the invention, the monofilaments can be provided as polyphenylene sulfide.

In accordance with another aspect of the invention, the foil layer is fixed to the outer surface, thereby forming an outermost layer of the sleeve.

In accordance with another aspect of the invention, the foil layer can be provided having a first end configured in generally flush relation with an inner one of the opposite edges of the wall and a cantilevered second end extending beyond an outer one of the opposite edges of the wall.

In accordance with another aspect of the invention, the foil layer can be bonded to the wall via an adhesive.

In accordance with another aspect of the invention, the adhesive can be provided as a pressure sensitive adhesive (PSA).

In accordance with another aspect of the invention, the adhesive extends along an inner face of the cantilevered second end, with the inner face being configured for adhesion to an outer face of the foil layer when the wall is in the tubular configuration, whereupon the foil layer extends in uninterrupted, circumferentially continuous relation about the wall.

In accordance with another aspect of the invention, a release film can be releasably bonded to the adhesive along the inner face of the cantilevered second end, with the release film being configured to be selectively removed from the adhesive to allow the inner face to be bonded to the outer face of the foil layer to fix the wall in the tubular configuration and form the foil layer being circumferentially continuous to maximize shielding against EMI.

In accordance with another aspect of the invention, the foil layer can be provided as an impervious conductive metal foil layer.

In accordance with another aspect of the invention, the foil layer can be provided as an aluminum foil.

In accordance with another aspect of the invention, the foil layer can be fixed to the inner surface of the wall to form an innermost layer of the sleeve.

In accordance with another aspect of the invention, the foil layer, whether fixed to the outer surface and/or to the inner surface of the wall, can be provided having a first end configured in generally flush relation with an inner one of the opposite edges of the wall and a second end configured in generally flush relation with an outer one of the opposite edges of the wall.

In accordance with another aspect of the invention, a method of constructing a wrappable, woven EMI resistant sleeve for routing and protecting an elongate member is provided. The method includes weaving a wall with warp filaments extending generally parallel to a central longitudinal axis and weft filaments extending generally transversely to the warp filaments, with one or more of the warp filaments including wire, with the wall having opposite edges extending lengthwise between opposite ends. Further, heat-setting the wall to cause the opposite edges to be biased into overlapping relation with one another such that the wall takes on a tubular configuration with an inner surface of the wall bounding an enclosed cavity sized for receipt of the elongate member therein, and with an outer surface of the wall facing radially outwardly from the central longitudinal axis. Further yet, adhering a foil layer in fixed relation to at least one of the outer surface and the inner surface of the wall.

In accordance with another aspect of the invention, the method can further include forming the foil layer to extend in uninterrupted, circumferentially continuous relation about the wall.

In accordance with another aspect of the invention, the method can further include adhering the foil layer to the outer surface of the wall.

In accordance with another aspect of the invention, the method can further include leaving the entirety of the inner surface of the wall being free of the foil layer.

In accordance with another aspect of the invention, the method can further include adhering the foil layer to the inner surface of the wall.

In accordance with another aspect of the invention, the method can further include adhering the foil layer to the entirety of the inner surface of the wall.

In accordance with another aspect of the invention, the method can further include adhering the foil layer to the inner surface of the wall and to the outer surface of the wall.

In accordance with another aspect of the invention, the method can further include adhering the foil layer to the entirety of the inner surface of the wall and to a portion of the outer surface of the wall, with the foil layer extending in uninterrupted, circumferentially continuous relation.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is schematic perspective view of a self-wrapping sleeve constructed in accordance with one aspect of the invention, with the sleeve shown carrying and protecting an elongate member therein;

FIG. 1A is an end view of the self-wrapping sleeve of FIG. 1 looking generally along the arrow 1A of FIG. 1;

FIG. 1B is a view similar to FIG. 1A of a self-wrapping sleeve constructed in accordance with another aspect of the disclosure;

FIG. 1C is a view similar to FIG. 1A of a self-wrapping sleeve constructed in accordance with another aspect of the disclosure;

FIG. 2 is a side view of the sleeve of FIG. 1A shown prior to be formed into a tubular configuration;

FIG. 3 is a plan view of FIG. 2; and

FIG. 4 is a fragmentary schematic view of a woven wall of the sleeves of FIGS. 1A-1C.

### DETAILED DESCRIPTION OF PREFERRED EMBODIMENTS

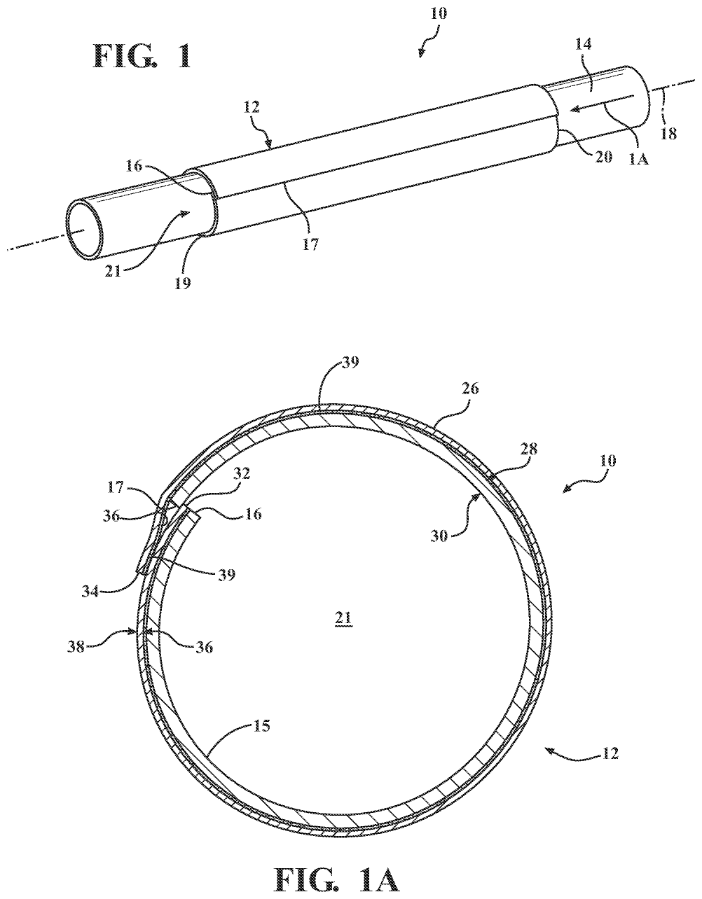

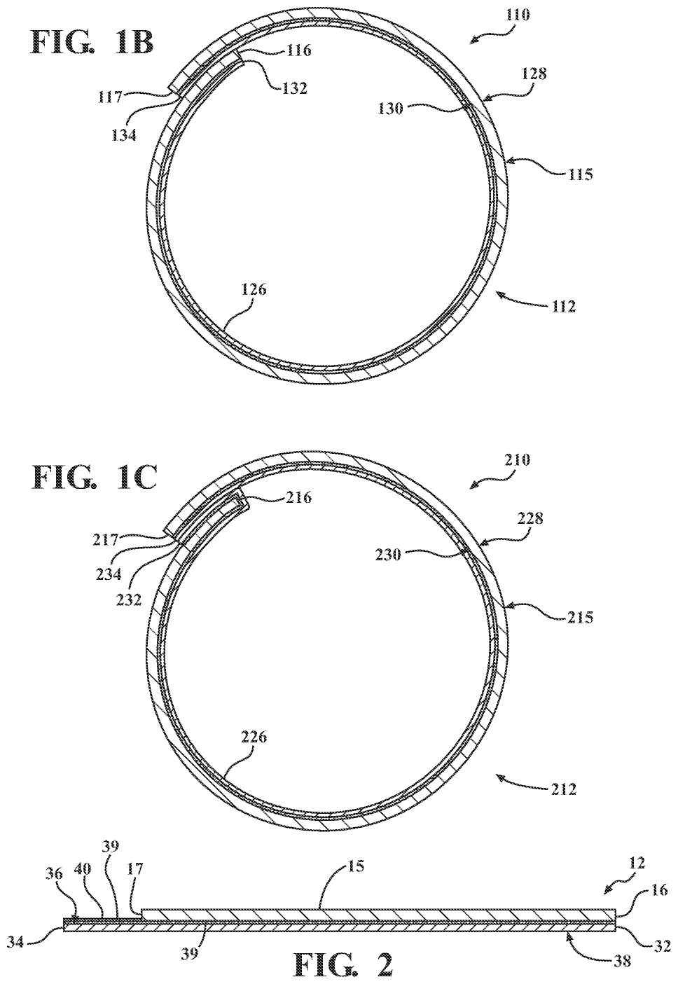

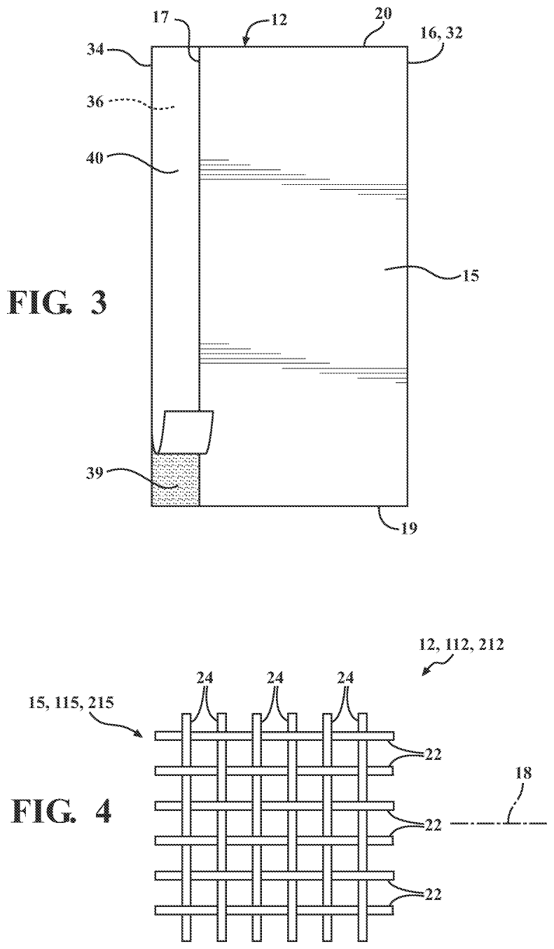

Referring in more detail to the drawings, FIGS. 1, 1A, 2 and 3 show a schematic representation of wrappable (shown wrapped in FIG. 1), EMI resistant woven sleeve, referred to hereafter as sleeve 10, constructed in accordance with one aspect of the invention. The sleeve 10 has a wrappable elongate wall 12 for routing and protecting an elongate member(s), such as wires or a wire harness 14, for example, from exposure to EMI, abrasion, impact, and other environmental conditions, such as contamination from fluid and debris. The elongate wall 12 has opposite edges 16, 17 extending parallel or generally parallel (meaning though not truly parallel, to a casual observer, the edges 16, 17 would be seen and described as being parallel) to a central, longitudinal axis 18 between opposite ends 19, 21, wherein the edges 16, 17 are wrappable into overlapping relation with one another in “cigarette wrapped” fashion to fully enclose the elongate members 14 within a central cavity 21 of the sleeve 10. The cavity 21 is readily accessible along the full length of the wall 12, via separation of the opposite edges 16, 17 away from one another, so that the elongate member(s) 14 can be readily disposed radially, relative the axis 18, into the cavity 21, and conversely, removed from the cavity 21, such as during service. As best shown in FIG. 4 (illustrating a portion of an innermost layer 15 of the wall 12, wherein the portion is representative of the entirety of the innermost layer 15 of the wall 12), the textile innermost layer 15 of the wall 12 is woven with warp filaments 22 (FIG. 4) extending parallel or generally parallel to the central longitudinal axis 18 and weft filaments 24 extending transversely or generally transversely to the warp filaments 22. To provide resistance to low frequency EMI, such as less than 100 MHz, at least some of the warp filaments 22 are electrically conductive wire, such as having a diameter between about 0.05-0.2 mm, and in one non-limiting embodiment, a diameter between 0.8-1.2 mm, by way of example and without limitation. To maximize protection against low frequency EMI, all the warp filaments 22 can be provided as wire, including individual continuous filaments, or bundled wire filaments, such as mini-braids of continuous wire filaments. The wire can be provided having a copper core encapsulated by an outer layer of tin, or copper coated nickel, by way of example and without limitation. To provide resistance to high frequency EMI, such as greater than 100 MHz, and very high frequency EMI, greater than 1000 MHz, a conductive foil layer 26 is fixed to at least one of an outer surface 28 and an inner surface 28 of the wall 12, wherein the foil layer 26 is shown in FIG. 1A as being an outermost layer adhered to the outer surface 28 of the wall 12.

The wall 12 can be constructed having any suitable size, including length and diameter, depending on the application.

The wall 12 is formed to be self-wrapping by providing at least some or all of the weft filaments 24 being heat-set into a curled shape to bias the opposite edges 16, 17 into overlapping relation with one another. The heat-set weft filaments 24 are provided as heat-settable monofilaments to maximize the self-curling bias upon being heat-set, and further, can be provided as a polyphenylene sulfide material to provide excellent balance of properties, including high temperature resistance, chemical resistance, flowability, dimensional stability and electrical characteristics. The wall 12, upon being formed, can be wrapped about a mandrel having a predetermined diameter, with the opposite edges 16, 17 brought into the desired overlapping relation with one another, and then a suitable heat can be applied to the wall 12 to cause the heat-settable weft yarns 24 to be heat-set, whereupon the heat-set weft yarns 24 take on a curled shape having a radius of curvature of the mandrel, thereby providing a source of internal bias to the wall 12 to bias and maintain the opposite edges 16, 17 in overlapping relation with one another. Of course, the opposite edges 16, 17 can be spread apart from one another under a suitable externally applied force sufficient to overcome the bias imparted by the heat-set weft yarns 24, such as may be desired to install, service or replace the elongate member 14.

As shown in FIGS. 1A, 2 and 3, the foil layer 26, which can be provided from any desired conductive, flexible metal foil material, such as an impervious foil layer of tin or aluminum, by way of example and without limitation, has a first end 32 configured in flush or generally flush relation (although not perfectly flush, a casual observer would describe the relation as flush) with an inner one of said opposite edges 16 and an cantilevered second end 34 extending beyond (relative to the axis 18) an outer one of the opposite edges 17. The foil layer 26 can be provided having a thickness ranging between about 10-500 μm. The foil layer 26 is bonded to the textile layer 15 of the wall 12 via an adhesive 39. The adhesive 39 extends along an inner face 36 of the cantilevered second end 34, with the inner face 36 being configured for adhesion to an outer face 38 of the foil layer 26 when the wall 12 is wrapped in its tubular configuration. As such, the foil layer 26 extends in uninterrupted, circumferentially continuous relation about the wall 12, thereby optimizing the EMI resistance. A release film 40 is releasably bonded to the adhesive 39 along the inner face 36 of the cantilevered second end 34. The release film 40 is configured to be selectively removed from the adhesive 39 to allow the inner face 36 to be bonded to the outer face 38 of the foil layer 26 to fix the wall 12 in the tubular configuration.

With reference to FIG. 1B, a sleeve 110 constructed in accordance with another aspect of the disclosure is shown, wherein the same reference numerals as used above, offset by a factor of 100, are used to identify like features. The sleeve 110 has a foil layer 126 fixedly adhered to an inner surface 130 of a textile layer 115 of the wall 112. The textile layer 115 of the wall 112 is constructed in similar fashion as discussed above for the textile layer 15, and thus, no further discussion believed necessary. The difference is with regard to the fixation of the foil layer 126 on the inner surface 130 of the textile layer 115 rather than on an outer surface 128. The foil layer 126 has a first end 132 configured in generally flush relation with an inner one of an opposite edge 116 of the wall 112 and a second end 134 configured in generally flush relation with an outer one of an opposite edge 117 of the wall 112. Otherwise, the sleeve 110 is the same as sleeve 10.

With reference to FIG. 1C, a sleeve 210 constructed in accordance with another aspect of the disclosure is shown, wherein the same reference numerals as used above, offset by a factor of 200, are used to identify like features. The sleeve 210 has a foil layer 226 fixedly adhered to an entirety of an inner surface 230 of a textile layer 215 of the wall 212, starting adjacent an outer edge 217 of the textile layer 215 of the wall 212 and extending along the entirety of the inner surface 230 and about an inner edge 216 of the textile layer 215 of the wall 212, and then along at least a portion of an outer surface 228 of the textile layer 215 of the wall 212 adjacent the inner edge 216. The textile layer 215 of the wall 212 is constructed in similar fashion as discussed above for the textile layer 15, and thus, no further discussion believed necessary. The difference is with regard to the fixation of the foil layer 226 on the inner surface 230 and on the outer surface 228 of the textile layer 215. Upon the outer edge 217 of the textile layer 215 being wrapped into overlapping relation with the inner edge 216 of the textile layer 215, a first end 232 of the foil layer 226, wrapped about the inner edge 216 of the textile layer 215, and a second end 234 of the foil layer 226, configured in flush or generally flush relation with the outer edge 217 of the textile layer 215, are brought into contact with one another in overlapping relation, and thus, the foil layer 226 extends in uninterrupted, circumferentially continuous relation about the inner surface 23 of the wall 212. Otherwise, the sleeve 210 is the same as sleeve 10.

In accordance with another aspect of the invention, a method of constructing a wrappable, woven EMI resistant sleeve 10, 110, 210 for routing and protecting an elongate member 14 is provided. The method includes weaving a textile layer 13, 115, 215 of a wall 12, 112, 212 with warp filaments 22 extending generally parallel to a central longitudinal axis 18 and weft filaments 24 extending generally transversely to the warp filaments 22, and providing one or more of the warp filaments 22 including conductive wire, with the textile layer 15, 115, 215 of the wall 12, 112, 212 being formed having opposite edges 16, 17; 116, 117; 216, 217 extending lengthwise between opposite ends 19, 20. Further, heat-setting the textile layer 15, 115, 215 of the wall 12, 112, 212 to cause the opposite edges 16, 17; 116, 117; 216, 217 to be biased into overlapping relation with one another such that the wall 12, 112, 212 takes on a self-wrapping tubular configuration with an inner surface 30, 130, 230 of the wall 12, 112, 212 bounding an enclosed cavity 21 sized for receipt of the elongate member 14 therein, with an outer surface 28, 128, 228 of the wall 12, 112, 212 facing radially outwardly from the central longitudinal axis 18. Further yet, adhering a foil layer 26, 126, 226 fixed to at least one of the outer surface 28, 128, 228 and the inner surface 30, 130, 230 of the wall 12, 112, 212.

In accordance with another aspect, the method can further include forming the foil layer 26, 226 to extend in uninterrupted, circumferentially continuous relation about the wall 12, 212.

In accordance with another aspect, the method can further include providing the foil layer 26, 226 as an impervious layer of conductive metal.

In accordance with another aspect, the method can further include providing the foil layer 26, 226 having a thickness between about 10-500 μm.

In accordance with another aspect, the method can further include adhering the foil layer 26, 226 to the outer surface 28, 228 of the textile layer 15, 215 of the wall 12, 212.

In accordance with another aspect, the method can further include leaving the entirety of the inner surface 30 of the textile layer 15 of the wall 12 being free of the foil layer 26.

In accordance with another aspect, the method can further include adhering the foil layer 126, 226 to the inner surface 130, 230 of the textile layer 115, 215 of the wall 112, 212.

In accordance with another aspect, the method can further include adhering the foil layer 226 to the entirety of the inner surface 230 of the textile layer 215 of the wall 212 and to at least a portion of the outer surface 228 of the wall 2

d12.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A wrappable, woven EMI resistant sleeve for routing and protecting an elongate member, comprising:
a wall having opposite edges extending lengthwise between opposite ends, said opposite edges being configured to be wrapped about a central longitudinal axis, whereupon said wall takes on a tubular configuration having an inner surface of said wall bounding an enclosed cavity sized for receipt of the elongate member therein and an outer surface of said wall facing radially outwardly from said central longitudinal axis, said wall being woven with warp filaments extending generally parallel to said central longitudinal axis and weft filaments extending generally transversely to said warp filaments, at least one or more of said warp filaments being wire; and
a foil layer fixed to at least one of said outer surface and said inner surface of said wall.

2. The wrappable, woven EMI resistant sleeve of claim 1, wherein each of said warp filaments is wire.

3. The wrappable, woven EMI resistant sleeve of claim 1, wherein said wire has a copper core encapsulated by an outer layer of tin.

4. The wrappable, woven EMI resistant sleeve of claim 1, wherein one or more of said weft filaments is heat-set to bias said opposite edges into overlapping relation with one another.

5. The wrappable, woven EMI resistant sleeve of claim 4, wherein each of said heat-set weft filaments is a monofilament.

6. The wrappable, woven EMI resistant sleeve of claim 5, wherein said monofilaments are polyphenylene sulfide.

7. The wrappable, woven EMI resistant sleeve of claim 1, wherein said foil layer is fixed to said outer surface.

8. The wrappable, woven EMI resistant sleeve of 7, wherein said foil layer has a first end configured in generally flush relation with an inner one of said opposite edges and a cantilevered second end extending beyond an outer one of said opposite edges.

9. The wrappable, woven EMI resistant sleeve of claim 8, wherein said foil layer is bonded to said wall via an adhesive.

10. The wrappable, woven EMI resistant sleeve of claim 9, wherein said adhesive extends along an inner face of said cantilevered second end, said inner face being configured for adhesion to an outer face of said foil layer when said wall is in the tubular configuration, whereupon said foil layer extends in uninterrupted, circumferentially continuous relation about said wall.

11. The wrappable, woven EMI resistant sleeve of claim 10, further including a release film releasably bonded to said adhesive along said inner face of said cantilevered second end, said release film being configured to be selectively removed from said adhesive to allow said inner face to be bonded to said outer face of said foil layer to fix said wall in the tubular configuration.

12. The wrappable, woven EMI resistant sleeve of claim 11, wherein said foil layer is an impervious layer of conductive metal.

13. The wrappable, woven EMI resistant sleeve of claim 1, wherein said foil layer is fixed to said inner surface.

14. The wrappable, woven EMI resistant sleeve of claim 13, wherein said foil layer has a first end configured in generally flush relation with an inner one of said opposite edges and a second end configured in generally flush relation with an outer one of said opposite edges.

15. The wrappable, woven EMI resistant sleeve of claim 13, wherein said foil layer extends in uninterrupted, circumferentially continuous relation about said wall.

16. The wrappable, woven EMI resistant sleeve of claim 15, further including a release film releasably bonded to said foil layer, said release film being configured to be selectively removed from said adhesive to allow an inner face of said foil layer to be bonded to an outer face of said foil layer to fix said wall in the tubular configuration.

17. A method of constructing a wrappable, woven EMI resistant sleeve for routing and protecting an elongate member, comprising:
weaving a wall with warp filaments extending generally parallel to a central longitudinal axis and weft filaments extending generally transversely to the warp filaments, with one or more of the warp filaments including wire, with the wall having opposite edges extending lengthwise between opposite ends;
heat-setting the wall to cause the opposite edges to be biased into overlapping relation with one another such that the wall takes on a tubular configuration with an inner surface of the wall bounding an enclosed cavity sized for receipt of the elongate member therein, with an outer surface of the wall facing radially outwardly from the central longitudinal axis; and
adhering a foil layer to at least one of the outer surface and the inner surface of the wall.

18. The method of claim 17, further including forming the foil layer to extend in uninterrupted, circumferentially continuous relation about the wall.

19. The method of claim 18, further including adhering the foil layer to the outer surface of the wall.

20. The method of claim 18, further including further including adhering the foil layer to the inner surface of the wall.
